(19) United States
(12) Patent Application Publication
(10) Pub. No.: US 2011/0112922 A1
(43) Pub. Date: May 12, 2011

(54) SYSTEMS AND METHODS FOR ASSISTING CONSUMERS IN NEGOTIATING PURCHASES WITH A PLURALITY OF SELLERS

(76) Inventor: Thomas D. Smith, Marina del Rey, CA (US)

(21) Appl. No.: 12/941,052

(22) Filed: Nov. 6, 2010

Related U.S. Application Data
(60) Provisional application No. 61/259,024, filed on Nov. 6, 2009.

(51) Int. Cl. G06Q 30/00

(52) U.S. Cl. 705/26.2

(57) ABSTRACT

Systems and methods for assisting a consumer in negotiating with a plurality of sellers for the purchase of products and/or services are provided. A consumer provides search criteria for generating a list of potential sellers to participate in the negotiations. From this list, the consumer selects a plurality of sellers to receive invitations to participate in the negotiations. Invitations are then sent to each of the sellers selected by the consumer inviting each of the sellers to participate in the negotiations. Each of the sellers may opt-in or opt-out of the negotiations. Once all sellers have opted-in or opted-out, either directly or indirectly, the negotiations with the sellers that have opted-in begin. During a pre-determined time period, each of the participating sellers may update quotes for the purchase of the product. At the end of the time period, the consumer may select the winning seller and complete the transaction.

### CLAIM OF PRIORITY UNDER 35 U.S.C. §119

The present Application for Patent claims priority to U.S. Provisional Application No. 61/259,024 entitled “USER ASSISTED NEGOTIATIONS”, filed Nov. 6, 2009, and hereby expressly incorporated by reference herein.

### FIELD

The present invention relates to systems and methods for on-line lead generation, and more specifically to systems and methods for assisting users in negotiating purchases of products and/or services with a plurality of sellers.

### BACKGROUND

In business, reliable sales leads are critical in generating new business and represent the first stage of a sales process. A sales lead is the identity of a person or entity potentially interested in purchasing a product and/or service. One way for a business to obtain sales leads is to purchase Internet leads from agencies that develop websites or partnerships with several websites in which they promote and advertise products and/or services. A consumer finds these directories or informational sites and may complete an online quote request form which is submitted to the agency. The agency may then match these leads to businesses and the businesses are then provided with a consumer's full contact information and purchasing requirements.

When businesses purchase these leads, they are typically paying $19-$25 (or more) per lead. In many instances, there are problems associated with these leads. For instance, the businesses are purchasing leads they already have, the leads are being shared with many other businesses and/or the leads are bogus, not “scrubbed”. In other words, the leads may include false information and result in money and time being wasted by the businesses that purchased the lead.

Therefore, a system and method are needed that provide businesses with quality, reliable leads while allowing the consumer to receive the best deal possible.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one feature, the present invention provides a system and method for assisting a consumer with negotiating with a plurality of sellers for the purchase of products and/or services. Negotiating with the plurality of sellers simultaneously allows the consumer to achieve the best possible deal as the sellers compete with each other for the business of the consumer in plain view via a website. Each of the sellers may continually update its quote (or bid) during the negotiations which occur over a pre-determined time period. The pre-determined time period may vary and may be, for example, 4 hours, 8 hours, 2 days or 3 days. At the end of the pre-determined time period, the negotiations are over and the consumer may select one or more of the sellers to directly continue the negotiations and potentially complete the transaction for the purchase of the products and/or services. The selected seller(s) (or the winning seller(s)) may then be provided with the contact information of the consumer which, as a result, generates a new lead for the winning seller (s). The consumer may select the winning seller(s) based on a variety of different criteria all of which are determined by the consumer, including price, time of delivery and additional features included in the price.

In one aspect of the present invention, a method operational on a negotiations manager for assisting a consumer in negotiating a purchase of products and/or services with a plurality of sellers is provided. After registering a consumer and verifying the authenticity of the consumer, the negotiations manager may receive search criteria from the consumer and using the search criteria, generate a list of potential sellers to participate in the negotiations. The list of potential sellers may then be provided to the consumer along with a request for the consumer to select a plurality of sellers from the list to receive invitations to participate in the negotiations. Once selected, invitations to participate in the negotiations may be sent to each of the plurality of sellers selected by the consumer. The negotiations manager may receive responses from the sellers accepting or declining the invitation to participate in the negotiations. Failure to respond (i.e. opt-in or opt-out) may be construed as declining the invitation and opting-out of the negotiations. Negotiations with participating sellers may then be initiated.

Each seller may have access to the offers made by the other sellers and each seller may adjust its quote accordingly. Quotes by the sellers may be updated in real time or may be updated or refreshed at specific times, for example, every 15 minutes or every hour after the negotiations have begun. During the negotiations, the consumer may have access to negotiations and the quotes of the sellers; however, the consumer remains anonymous to the sellers. Once the predetermined time period is over and the negotiations have been completed, the consumer may select one or more of the sellers to continue the negotiations directly and possibly complete the business transaction. Once a winning seller(s) has been chosen by the consumer, the winning seller(s) may then receive the contact information of the consumer which may be a reliable lead for the seller to follow up on.

In yet another aspect of the present invention, the negotiations system may allow for consumers to research products and services of particular interest. For example, if the consumer is looking to purchase a car, the consumer can review the safety history and ratings of specific cars, estimated gas mileage, available accessories, specifications, performance, reliability, and owner satisfaction of various cars. Consumers may research products and services prior to or after registering with the system. Additionally, consumers may be provided with consumer reviews of potential sellers prior to selecting which sellers are to receive invitations.

In yet another aspect of the present invention, sellers may pay a participatory fee to be considered for participating in negotiations. The participatory fee may be a one-time fee, a monthly fee or another other fee as determined by the negotiations manager. The winning seller(s) may also pay an access fee prior to receiving the contact information for the consumer. The access fee may be a flat fee or may be a percentage of the final quoted price.

In yet another aspect, a negotiations manager for assisting a consumer in negotiating with a plurality of sellers for the purchase of products and/or services is provided. The negotiations manager may include a memory device; a seller services module, coupled to the memory device, for allowing sellers to update information on products and/or services for purchase; and a processing circuit coupled the seller services module. The processing circuit may be adapted to (i) receive search criteria from the consumer and generate a list of potential sellers to participate in the negotiations based on the search criteria; (ii) provide the list of potential sellers to the consumer; (iii) request the consumer select a plurality of sellers from the list of potential sellers to receive invitations to participate in the negotiations; (iv) send the invitations to the plurality of sellers selected by the consumer to inviting each of the plurality of sellers to participate in the negotiations; and (v) receive acceptances to the invitations from participating sellers and initiate the negotiations with the participating sellers.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a block diagram illustrating a general overview of a system for assisting consumers in negotiating purchases with a plurality of sellers, according to one embodiment of the present invention.

FIG. 2 illustrates a general structure of a system for assisting consumers in negotiating purchases with a plurality of sellers, according to one embodiment of the present invention.

FIG. 3 is a block diagram illustrating an example of a negotiations manager configured to assist one or more sellers to openly negotiate or compete for the business of a consumer in plain view via a website, according to one embodiment of the present invention.

FIG. 4 (comprising FIGS. 4A and 4B) is a flow diagram illustrating a method operational on a negotiations manager for assisting a consumer in negotiating purchases with a plurality of sellers, according to one embodiment of the present invention.

FIG. 5 illustrates a comparison of two vehicles generated by the system of FIG. 2.

FIG. 6 illustrates an example of customer reviews of a plurality of sellers generated by the system of FIG. 2.

FIGS. 7A and 7B illustrate examples of status screens provided to a consumer during the negotiations.

FIG. 8 is a flow diagram illustrating another method for assisting a consumer in negotiating purchases with a plurality of sellers.

FIG. 9 is a block diagram of a computing system for executing computer executable process steps according to one embodiment of the disclosure.

FIG. 10 is a block diagram illustrating the internal functional architecture of the computer of FIG. 9.

FIG. 11 shows a typical topology of a computer network with computers similar to the computer of FIG. 9, connected to the Internet.

### DETAILED DESCRIPTION OF THE INVENTION

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The present invention may be operable on any type of computing device, including, but not limited to, a desktop and a mobile device. The term “mobile device” includes, but is not limited to, a wireless device, a mobile phone, a mobile communication device, a user communication device, personal digital assistant, mobile palm-held computer, a laptop computer, a tablet (e.g. iPad®) and/or other types of mobile devices typically carried by individuals and/or having some form of communication capabilities (e.g., wireless, infrared, short-range radio, etc.).

According to one feature of the present invention, an online system is provided that assists consumers (also referred to as “buyers” or “users”) in negotiating with a plurality of sellers for the purchase of products and/or services. Additionally, the online system of the present invention provides for the plurality of sellers to compete for the business of the consumer, and as a result generate a new lead, by simultaneously and openly negotiating with themselves on behalf of the consumer who initiated the negotiations.

Some implementations of the present invention may allow a consumer to select the plurality of sellers (also referred to as “bidders”) to participate in the negotiations. The consumer may select the sellers from a listing of sellers who match the search criteria of the consumer. For example, a consumer may be purchasing a car and the search criteria may include, but is not limited to, a specific price range, the type of car (truck, sedan, sports car, etc.), fuel economy, color and available options. The consumer may be provided with a list of possible sellers which most closely match the search criteria.

Once the consumer has selected the sellers, each of selected sellers may be sent an invitation asking to participate in the negotiations. Each seller may elect to opt-in or opt-out of the negotiations. Once the participating sellers have been determined and the negotiations begin, the sellers may then begin to provide the consumer with a quote for the products and/or services the consumer is looking to purchase. The sellers may actively change their quote (or bid) during a predetermined time period in which the negotiations are occurring. In one embodiment, the consumer and each seller may have access to the quotes from all the sellers, i.e. each seller may be able to view what another seller has quoted. Once the predetermined time period is over and the negotiations have been completed, the consumer may select one or more of the sellers to directly continue the negotiations and potentially complete the business transaction for the purchase of the product and/or service. Once a seller(s) (or winning seller(s)) has been chosen, the winning seller(s) may then receive the contact information of the consumer which may be a reliable lead for the seller(s) to follow up on.

In one embodiment, sellers may pay a participatory fee to be entered into a database of sellers which is used to generate a list of sellers which most closely match search criteria provided by the consumer. The participatory fee may be a one time, a monthly fee, a yearly fee or any other fee structure known in the art. Alternatively, the participatory fee may be determined based on how many negotiations the seller participates in or in how many negotiations the seller is invited to participate in. For example, the seller may be billed for each negotiation that it participated in. Additionally, the winning seller may pay an access fee to obtain the lead (i.e. contact information of the consumer). The access fee may be a percentage of the final quoted price of the winning seller, a flat fee, or any other fee structure known in the art. In one embodiment, the consumer may not be required to pay any fees.

Yet another feature of the present invention provides an online system for allowing consumers to research products and services of particular interest. For example, if the consumer is looking to purchase a car, the consumer can review the safety history and ratings of specific cars, estimated gas mileage, available accessories, specifications, performance, reliability, and owner satisfaction. Consumers may research products and/or services either before or after registering with the system.

Yet another feature of the present invention provides an online system for allowing a consumer to rate various aspects of the seller, such as a car dealership. These aspects may include ratings of the overall buying process, the sales associate, the finance department and the overall value of the purchase. The ratings can be based on any type of scale, such as a scale of 100 or a scale of 10. Prior to selecting which sellers to invite to participate in the negotiations, the consumer may examine the reviews for each potential seller and use this information to select the sellers that will be invited to participate.

While the present invention is described primarily with respect to the purchase of cars, the present invention may be applied and adapted to the purchase of various products and/or services. For example, the present invention may be applied to, including but not limited to, banking, real estate, boats, yachts, watercraft, electronics, house hold repairs, furniture, or any other product and/or service. Furthermore, the present invention may be applied to any industry and any business for any product(s) and or service(s) whether the transaction is from business to business, from business to consumer or from consumer to consumer (i.e. private seller to private buyer).

### Exemplary Negotiations System

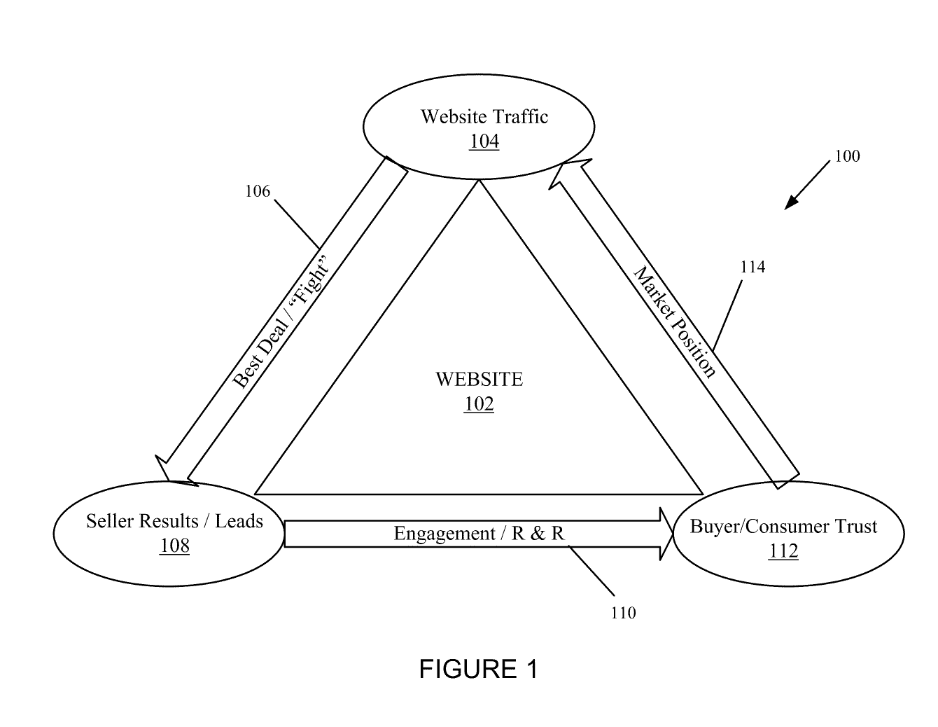

FIG. 1 is a block diagram illustrating a general overview of a system 100 for assisting consumers in negotiating purchases with a plurality of sellers. In the system, sellers may compete for the business of a consumer in plain view via a website 102. The seller may also compete for the business of a business entity. Website traffic 104 may be generated as consumers know that they may be receiving the best deal/“fight” 106 from the sellers. As the sellers begin to see results and are generating solid leads 108 of potential consumers, a new level of engagement to both consumers and sellers 110 may be created resulting in never before experienced results. This in turn may create consumer trust 112 based on the results they receive. As a result of the increase in consumer trust, the seller may be able to improve its market position 114. In one embodiment, the negotiations system may be referred to as an auction or reverse auction as sellers compete to provide a product or service to a buyer.

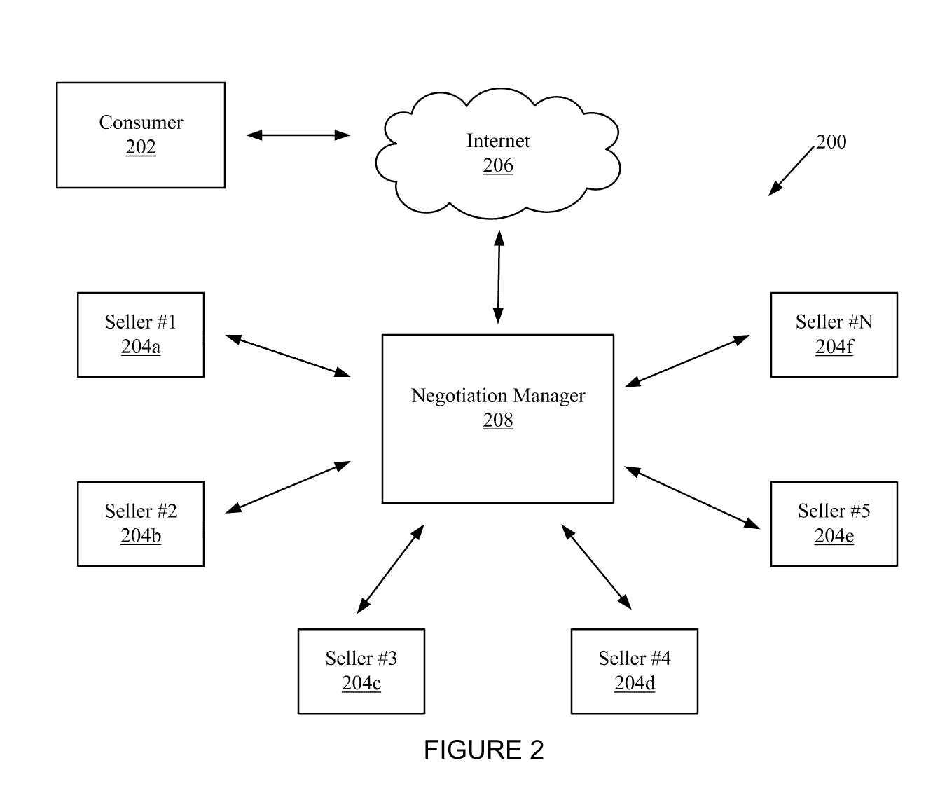

FIG. 2 illustrates a general structure of a system 200 for assisting consumers in negotiating purchases with a plurality of sellers. A consumer or buyer (hereinafter referred to interchangeably) 202 may wish to make a purchase of products and/or services without having to negotiate with multiple sellers 204a-204f individually to obtain the best deal. Although six (6) sellers are shown, this is by way of example and there may be more than (6) or less than (6) sellers. In one embodiment the best deal may be the lowest selling price of the product or service the buyer is looking to purchase. In other embodiments, the best deal may be based on an added value the seller may include in the negotiations, such as time of delivery, warranty plan, financing or any other criteria as may be determined by the consumer.

The consumer 202 may be coupled to a network 206, such as the Internet or Intranet, through which it communicates with a negotiations manager 208. The negotiations manager 208 may oversee the negotiations and act as the intermediary between the consumer and the sellers. To connect to the network, the consumer may use, for example, a mobile device, computer, desktop computer and a lap top computer. The negotiations manager 208 may establish the rules and framework by which the consumer 202 selects one or more sellers 204a-204f to openly negotiate for the business of the consumer. For example, the negotiations manager 248 may determine, including but not limited to, the maximum and minimum number of sellers that can participate in the negotiations, the length of the negotiations and the fees, if any, to be paid by the consumer and sellers for participating in the negotiations. Furthermore, the negotiations manager 248 may also determine the qualifications for the consumer and the sellers to participate in negotiations. For example, the negotiations manager 248 may establish that the consumer has the financial means to complete the transaction. The establishment of financial means may be verified using previous bills (e.g. utility bills), address of the consumer, checking the credit score of the consumer or any other method known in the art. The negotiations manager 248 may also establish that the seller is legitimate and has the products and/or services to sell. In one aspect, the consumer may be asked to put some or all of the anticipated cost of the purchase in escrow to ensure that the consumer is legitimate and has the financial ability to purchase the product and/or service.

As discussed below in more detail, the negotiations manager 248 may provide the consumer with a list of potential sellers whose products and/or services most closely match the criteria the consumer is looking for. Once the consumer 202 has selected the sellers 204a-204f to participate in the negotiations, the negotiations manager 208 may then notify the selected sellers of the opportunity to openly negotiate for the business of the consumer 202. The number of sellers selected to receive an invitation to participate in the negotiations may be determined by the consumer or the negotiations manager as defined by the rules. An invitation to participate in the negotiations may be sent electronically to the selected sellers by the negotiations manager 208. Upon receiving the invitation, each of the sellers may elect to participate in (i.e. opt-in) the negotiations or may opt out of the negotiations. In one embodiment, if a seller does not respond to an invitation within a set period of time as defined in the rules, the seller may be considered to have opted out of the specific negotiations. The invitation provided to each seller may include the details of the product and/or service that the consumer 202 wishes to purchase. According to one embodiment, identities of the consumer 202 and the sellers 204a-204f may be known to each other or they may remain anonymous during the negotiations.

Once the sellers 204a-204f have been selected and have agreed to participate in the negotiations by responding to the invitation (i.e. have opted-in), the negotiations may begin. In one embodiment, the negotiations may take place over a specified or pre-determined time period including, but not limited to, 90 minutes, 3 hours, 7 hours or 2 business days. Upon the expiration of that time period, the consumer 202 may select the best deal and the winning seller(s) may be provided with the contact information of the consumer (i.e. a lead). As described above, the best deal may be determined using criteria selected by the consumer. The contact information may include the name, address, e-mail, telephone number, mobile number, and/or fax number of the consumer. The winning seller may then use the lead to directly contact the consumer 202 to discuss and/or continue negotiating the purchase of the product and/or service 202. According to one embodiment, the consumer may specify the means in which to be contacted by the willing seller(s). The consumer/buyer and the winning seller(s) may be under no obligation to complete the transaction or purchase of the product and/or service. Furthermore, the lead may be exclusive or non-exclusive. For example, the seller selected by the consumer may be the only seller to receive the lead (i.e. exclusive). Alternatively, the consumer may rank all of the sellers that participated and it may be decided by the negotiations manager or the consumer that more than one seller may be provided with the lead, e.g. the top two sellers or the top three sellers.

### Negotiations Manager—Exemplary Operation

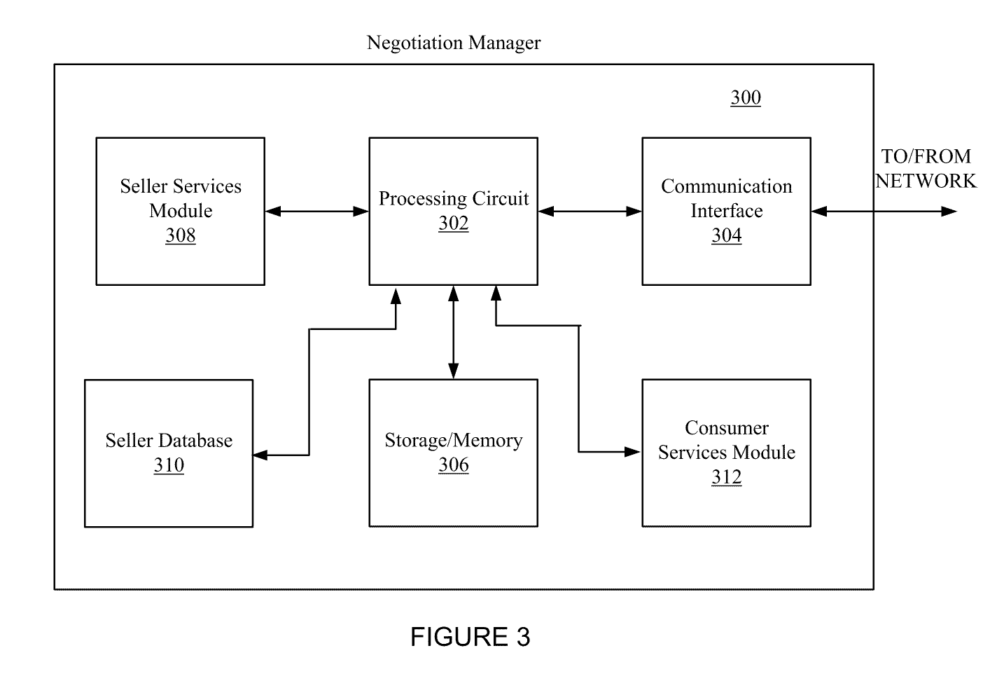

FIG. 3 is a block diagram illustrating an example of a negotiations manager 300 configured to assist a plurality of sellers to openly negotiate or compete for the business of a consumer in plain view via a website. The negotiations manager 300 may include a processing circuit 302 (e.g., processor, processing module, etc.) coupled to a communication interface 304 to communicate with a network, such as the Internet, and a memory device 306 to store information about the consumers. The information may include, but is not limited to, consumer contact information, consumer search criteria and statistics on leads provided to sellers. The processing circuit 302 may be coupled to a seller services module 308 to analyze the search criteria and provide a list of potential sellers most closely matching the search criteria to participate in the open negotiations. In other words, search criteria provided by the consumer may be utilized to find one or more sellers that sell the products and/or services the consumer is looking to purchase.

The seller services module 308 may allow sellers to update inventory information, i.e. products (such as cars) and/or services that are available for purchase. The inventory information may be updated or refreshed at predetermined times during the day. The number of times the inventory information is updated may be determined by the negotiations manager. Seller information, including but not limited to, contact information, current inventory (i.e. inventory information) and customer reviews may be stored in a seller database 310 which may be coupled to the processing circuit 302. A consumer services module 310, also coupled to the processing circuit 302, may allow consumers to register with the system so that they can be verified and determined to be legitimate consumers. Additionally, the consumer may access on-going negotiations via the consumer services module 310.

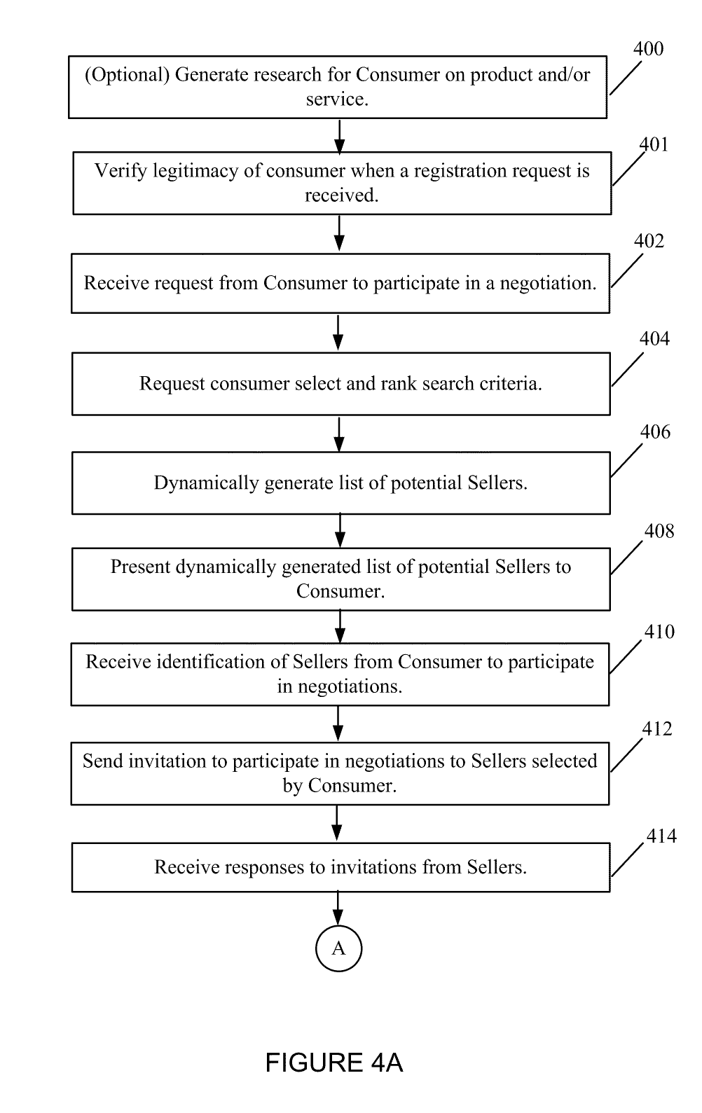

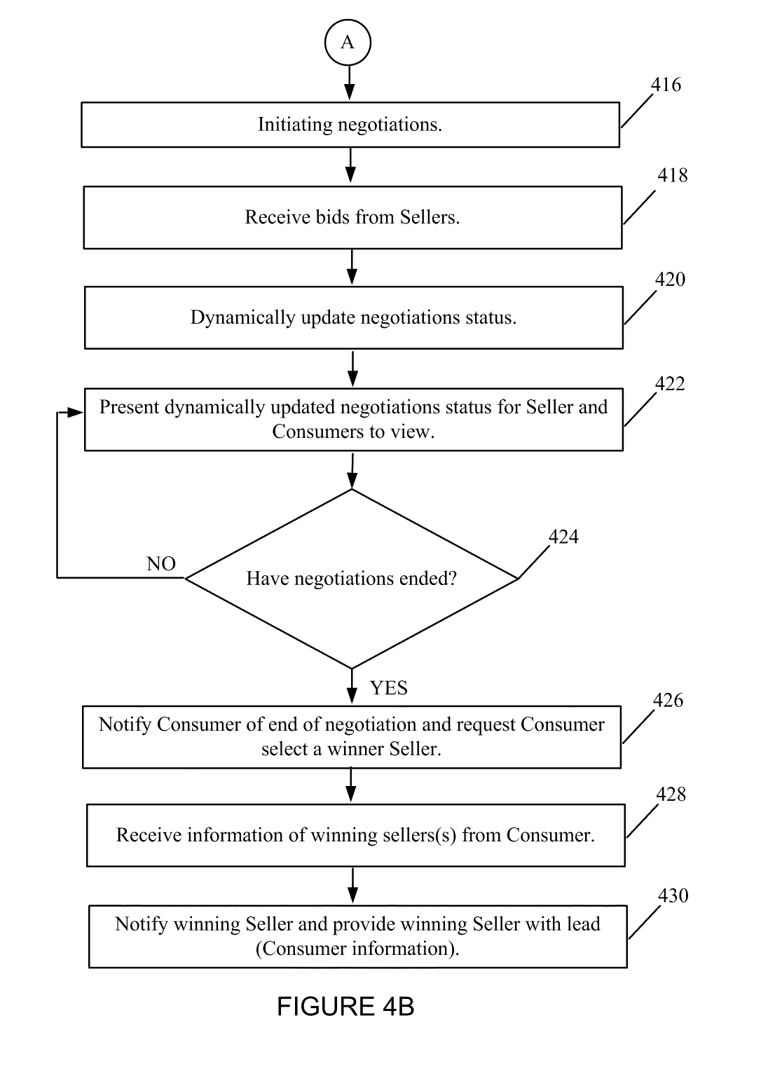

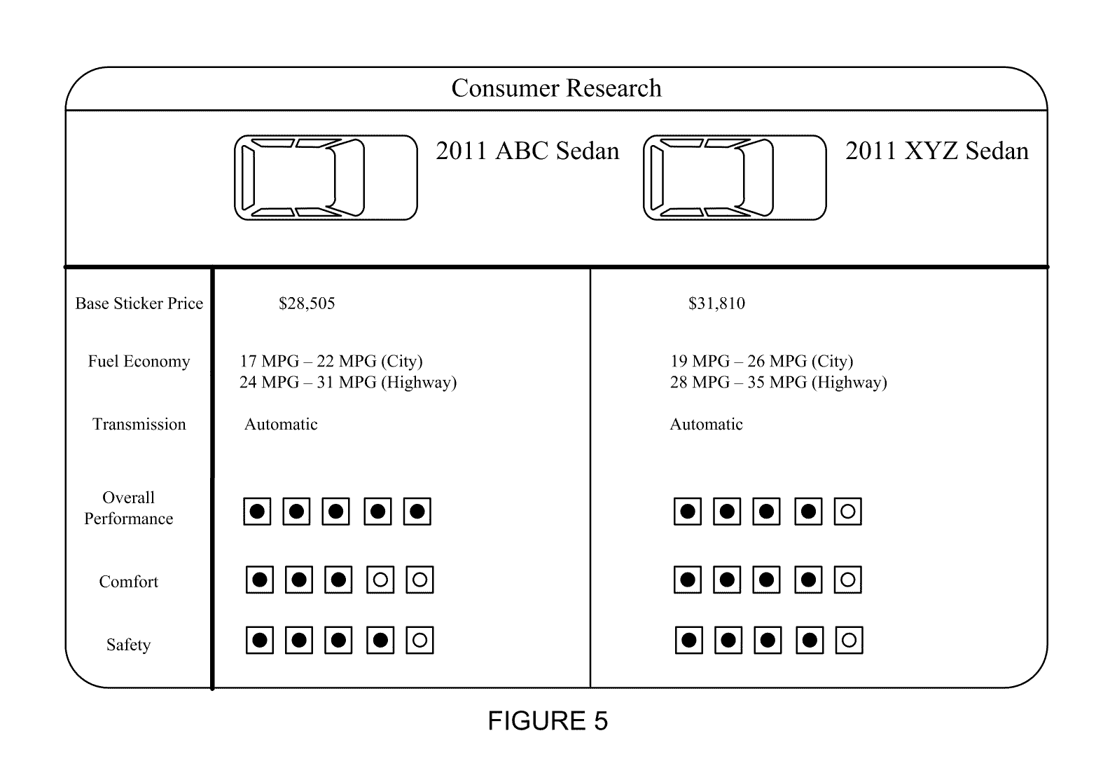

FIG. 4 (comprising FIGS. 4A and 4B) is a flow diagram illustrating a method operational on a negotiations manager for assisting consumers in negotiating purchases with a plurality of sellers. Optionally, the negotiations manager may receive a request from a consumer to generate research on a product and/or service the consumer is looking to purchase 400. For example, the consumer may want to purchase a new car but does not know whether to purchase a sports car, a sedan, a sport utility vehicle (SUV) or a truck. The consumer may also choose to compare two or more cars to determine how they compare on price, features fuel economy, performance, comfort, safety, etc. As shown in FIG. 5, the consumer may compare a 2011 ABC Sedan to a 2011 XYZ Sedan. The consumer may use research obtained via the system website to make a determination as to the product and/or service to purchase. The consumer may request research before or after registering for the system.

Prior to initiating negotiations, consumers may register for the system on-line or by filling out an application and mailing it in by traditional methods (such as post or first class mail), email or any other known method. Information to be provided by the consumer may include, but is not limited to, employment history, social security number, address, email address, telephone number, etc. Once the information for registration is received, the negotiations manager may then verify the legitimacy of the consumer to determine if the consumer is genuinely interested in purchasing products and/or services and has the financial means to purchase the products and/or services 401. When verifying the legitimacy of the consumer, the negotiations manager may verify the employment and salary information of the consumer, check the credit of the consumer to determine if the consumer will be able to qualify for a loan, if necessary, or any other means known in the art to determine if a customer has provided accurate information.

Once the consumer has been verified, the consumer may initiate negotiations to purchase a product and/or service by requesting to participate in negotiations with a plurality of sellers to purchase the product and/or service 402. Next, the negotiations manager may then request that the consumer select search criteria and rank the search criteria in order of most or least important 404. The search criteria may include information on the product and/or service the consumer is looking to purchase. For example, if the consumer wants to buy a car, the search criteria may include the price range the consumer is willing to spend, the type of car (for example a sedan), the preferred color of the car and options to be included in the car, including but not limited to, service contracts, vehicle delivery, additional parts and/or accessories, etc. In one embodiment, the consumer may rank the search criteria in order of importance so that the consumer may be provided with sellers that are able to provide the consumer with the product and/or service which most closely matches the criteria that is most important. For example, the pre-determined criteria may include the type of car (i.e. sedan, truck, etc.), transmission (i.e. manual or automatic), type of warranty, exterior color, interior color, audio packages, etc.

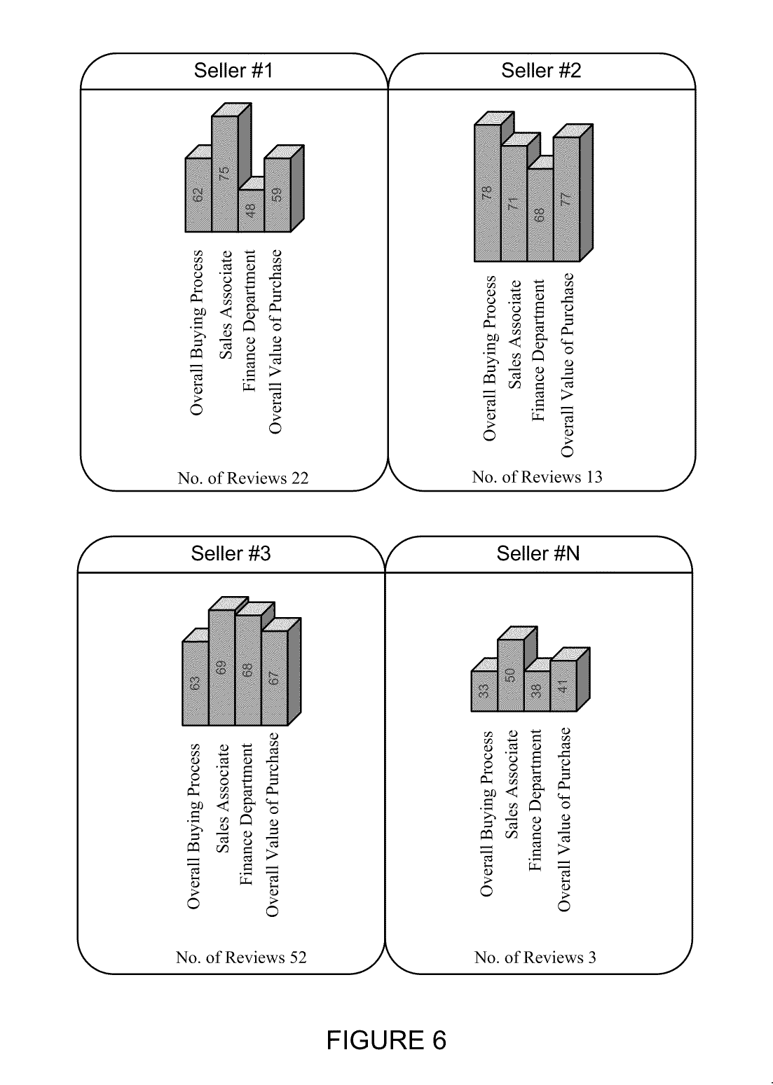

Next, the negotiations manager may dynamically generate a list of potential sellers/bidders for the consumer to select from 406. As discussed above, using the criteria provided by the consumer, a database of participating sellers may be searched to determine which sellers offer products and/or services that most closely match what the consumer is looking to purchase. This list may then be presented to the consumer 408 in addition to customer reviews of each seller. (See FIG. 6) Using the reviews and/or any other information available to the consumer, the consumer may select the sellers that will participate in the negotiations. As discussed above, the number of sellers chosen to participate in the negotiations may be determined by the consumer or by the negotiations manager.

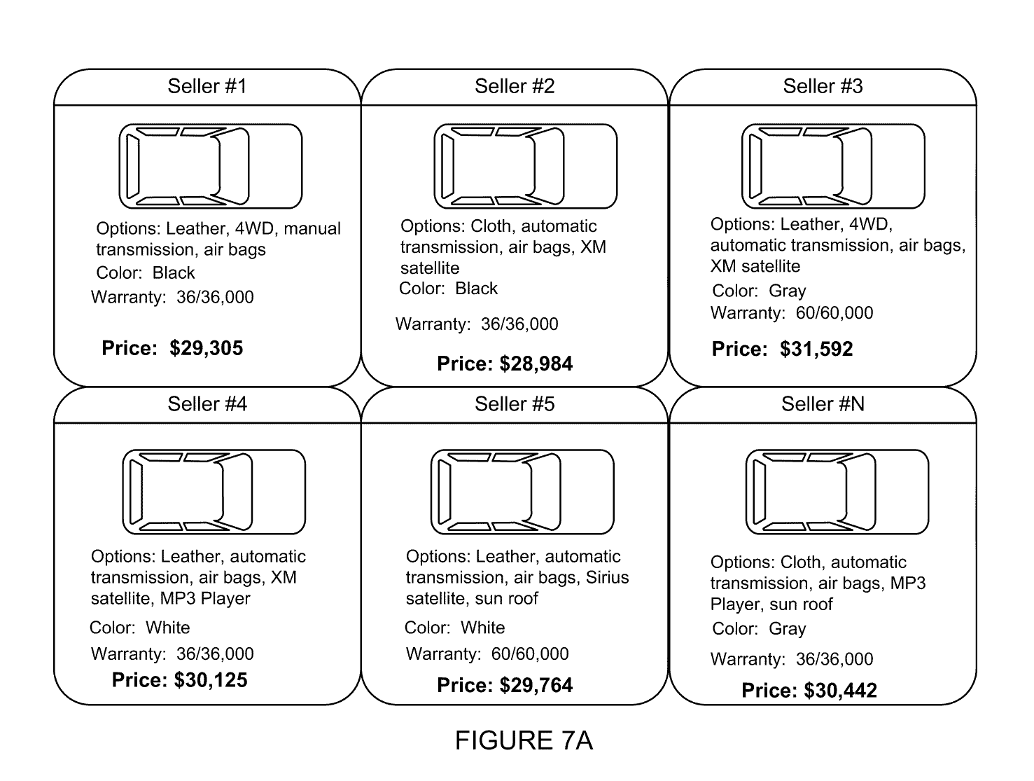

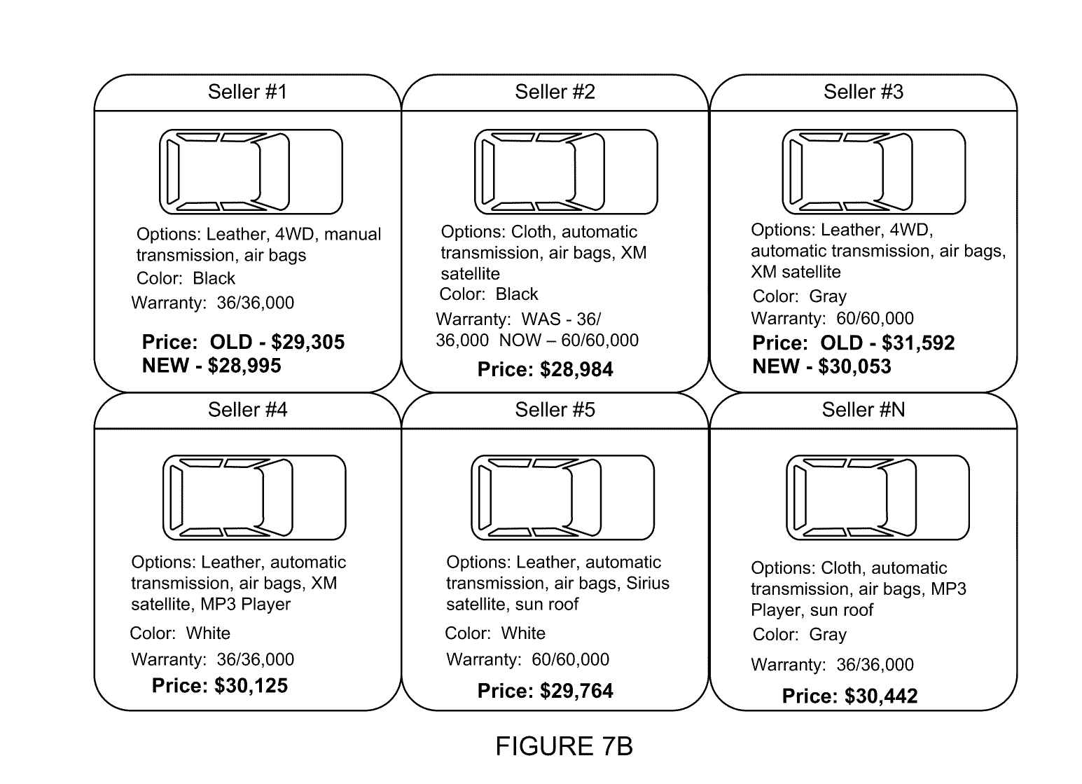

The negotiations manager may then be notified of, i.e. receive identification of, the selection of the sellers by the consumer to participate in the negotiations 410. After receiving the identity of the selected sellers, invitations may be sent to the selected sellers inviting them to participate in the negotiations 412. The invitation may be delivered to each potential seller electronically in the form of an e-mail, text message and/or any other method known in the art. The sellers may respond to the invitation by either accepting or rejecting the invitation 414. After all the responses have been received, or after a specified time period provided to the sellers in which to respond, the negotiations may begin 416. Once the negotiations have begun, the participating sellers may enter quotes/bids (i.e. suggested prices) for the product and/or service in which the consumer is seeking to purchase 418. Once a quote is received, the negotiations status may be dynamically updated 420 and the current status may be presented to the consumer 422. In other words, bids may be updated in real time and the consumer may be notified when a new quote is received via e-mail or text. Alternatively, the current status may be updated at a pre-determined time that may be selected by the negotiations manager or the consumer. The consumer may monitor the negotiations viewing status screens available to the consumer during the negotiations. (See FIGS. 7A and 7B) To access the status screens, the consumer may be provided with a user name and password which allows the consumer to view the status screens while the negotiations are in progress. Furthermore, the consumer and seller may be provided with their own unique uniform resource locator (URL) in which to monitor the negotiations.

A determination may be continually made as to the status of the auction/negotiations 424. That is, a determination may be made as to whether the pre-determined time period set for the negotiations has expired. If the pre-determined time period has not expired, quotes from the sellers may be continually received in real time 422. In one embodiment, the sellers may be provided with a warning that the time period for negotiations is about to expire. For example, each seller may receive a five (5) minute warning prior to the expiration of the pre-determined period. A five (5) minute warning is by way of example only and other lengths of time may be used to send a warning as to the end of the negotiations.

Alternatively, if the pre-determined time set for negotiations has expired, the sellers and the consumer may be notified of the end of the negotiations and the consumer may be requested to select the winning seller(s) 426. As discussed above, the consumer may select the winning seller(s) based on, including but not limited to, the prices, available options, time of delivery or warranty. After selecting the winning seller(s), the consumer may notify the negotiations manager 428. In other words, the consumer may inform negotiations manager of who the winning seller(s) is. Subsequently, the winning seller(s) may be notified by the negotiations manager and receive the contact information of the consumer (i.e. lead). The winning seller may then contact the consumer to complete the sale of the product and/or service or continue negotiations one on one. The consumer may specify how to be contacted. For example, the consumer may prefer to be contacted at home, at work, via e-mail or via a mobile phone number.

In one embodiment, only the latest quote by each seller is displayed. (See FIG. 5A) Alternatively, a history of each seller's quotes may be displayed. (See FIG. 5B) Additionally, a consumer may be able to print out the entire history of the negotiations.

In one embodiment, the pre-determined time period set for the negotiations may be determined by the negotiations manager. Alternatively, the consumer (or buyer) may determine the pre-determined time period.

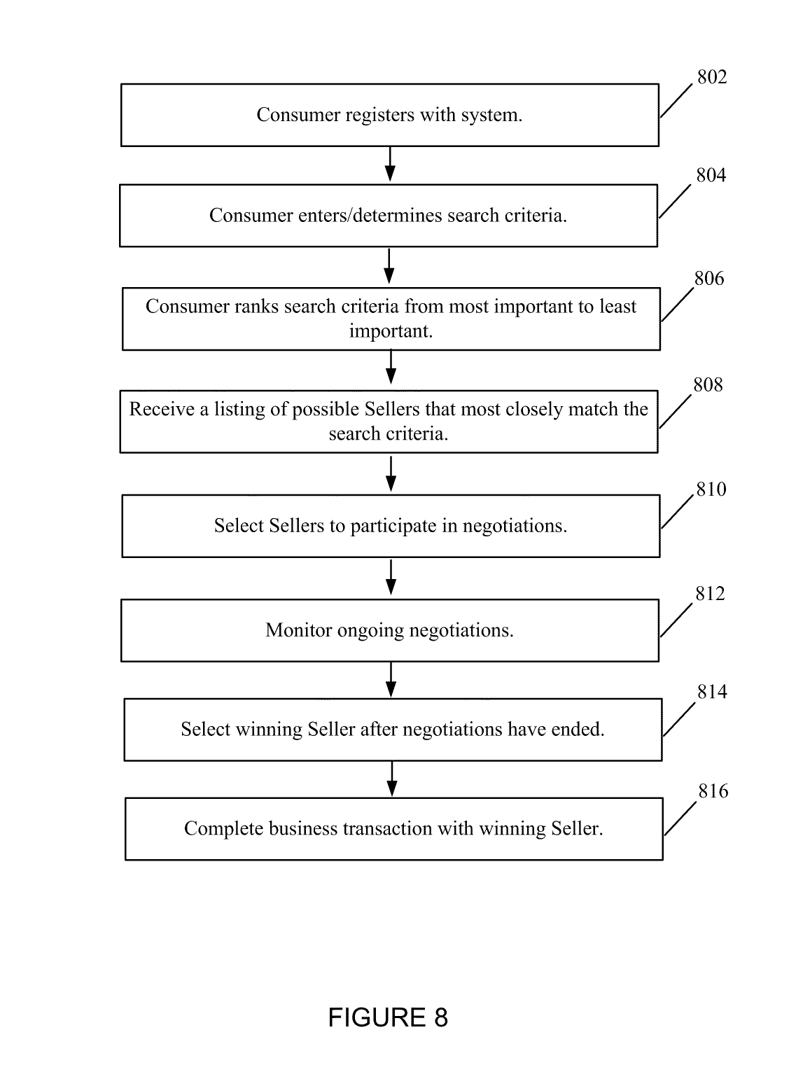

FIG. 8 is a flow diagram illustrating another method for assisting consumers in negotiating purchases with a plurality of sellers. Initially the consumer may register with the negotiations system 802. Once registered, the consumer may request to participate in negotiations to purchase products and/or services and provide the negotiations manager a list of search criteria 804. As discussed above, if a consumer is purchasing a car, the search criteria may include, but is not limited to, a price range, the type of car (truck, sedan, sports car, etc.), fuel economy, color and available options. Additionally, the consumer may use locality as a search criteria so as provide business to a local seller in the community. Next, the consumer may rank the search criteria from most important to least important (or vice-versa) 806. Using the search criteria, a list of potential sellers that offer products and/or services which most closely match the criteria provided by the consumer is generated. The consumer may then be provided with the list of possible sellers which most closely match the search criteria 808. From the list of possible sellers, the consumer may select the sellers which may participate in the negotiations 810. Once the negotiations have begun, the consumer may monitor the ongoing negotiations 812. When a pre-determined time period set for the negotiations has ended, the consumer may select the winning seller 814. As discussed above, the winning seller(s) may be chosen based upon various factors including, but not limited to, upon the prices, available options, time of delivery or warranty. The winning seller may then be provided with the contact information of the consumer so that the winning seller(s) may contact the consumer to discuss and/or continue negotiating the sale of product and/or service 816.

### Operating Environment

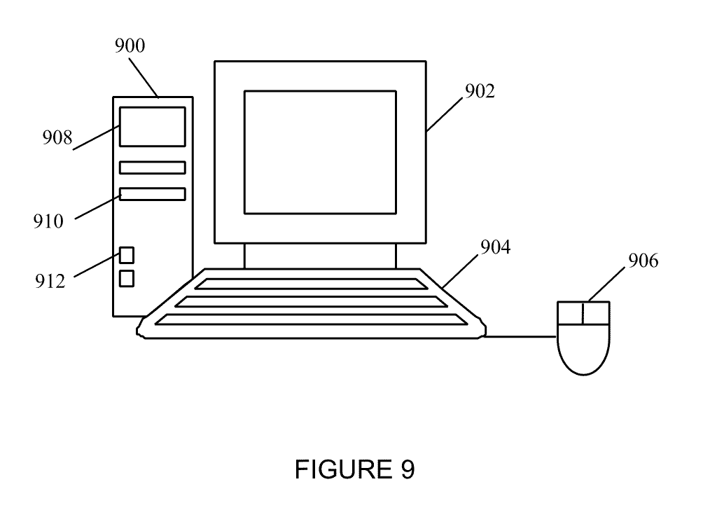

Various features of the online system described herein may be implemented over networked computing devices. FIGS. 9, 10, and 11 provide some examples of the type of devices and networks that may implement one or more features of the invention.

FIG. 9 is a block diagram of a computing system for executing computer executable process steps according to one embodiment of the disclosure. FIG. 9 includes a host computer 900 and a monitor 902. The monitor 902 may be a CRT type, an LCD type, or any other type of color or monochrome display. Also provided with the computer 900 is a keyboard 904 for entering text data and user commands, and a pointing device 906 (such as a mouse) for processing objects displayed on the monitor 902.

The computer 900 may include a computer-readable memory/medium such as a disk 908 for storing readable data. Besides other programs, the disk 908 can store application programs including web browsers by which the computer 900 connects to the Internet and the systems described below, according to one aspect of the disclosure.

A modem, an integrated services digital network (ISDN) connection, or the like may also provide the computer 900 with a DSL/Cable/satellite connection (or Internet connection) to the World Wide Web (“WWW”). The Internet connection may be used to allow the computer 600 to download data files, audio files, application program files and computer-executable process steps embodying the disclosure.

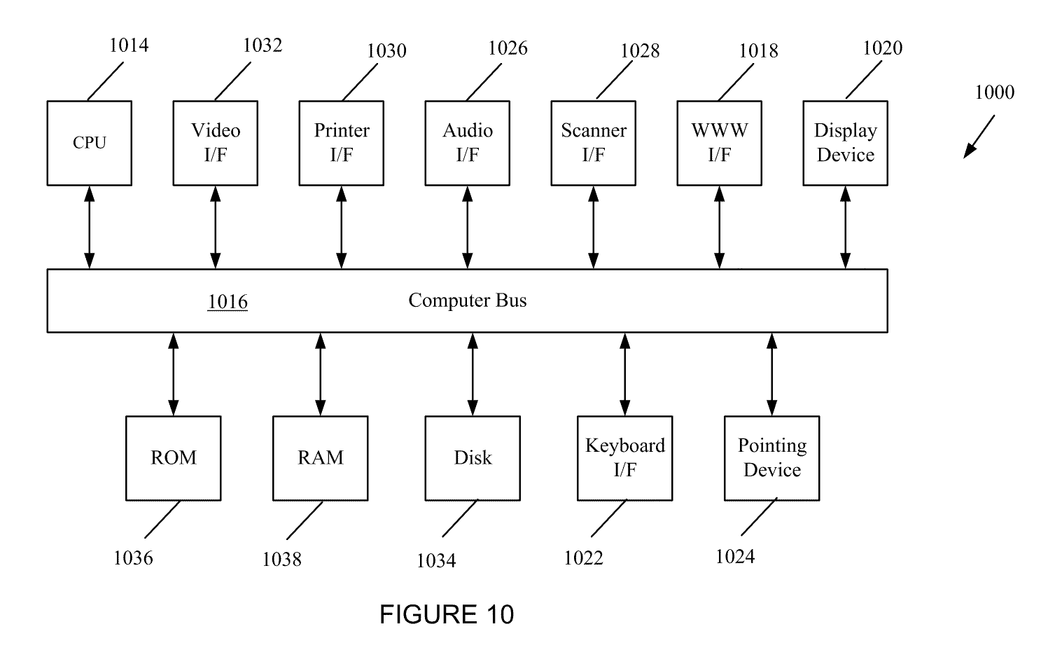

FIG. 10 is a block diagram illustrating the internal functional architecture of the computer 900. As shown in FIG. 10, the computer 900 may include a central processing unit (CPU) 1014 for executing computer-executable process steps and interfaces with a computer bus 1016. Also shown in FIG. 10 are a WWW interface 1018, a display device interface 1020, a keyboard interface 1022, a pointing device interface 1024, an audio interface 1026, a scanner interface 1028, a printer interface 1030, a video interface 1032, and a rotating disk 1034. The scanner interface 1028 can connect to a check scanner or imager (not shown) and a fingerprint scanner (not shown).

As described above, the disk 1034 may store operating system program files, application program files, web browsers, and other files. Some of these files may be stored on the disk 1034 using an installation program. For example, the CPU 1014 may execute computer-executable process steps of an installation program so that the CPU 1014 can properly execute the application program.

A random access main memory (“RAM”) 1036 may also interface to the computer bus 1016 to provide the CPU 1014 with access to memory storage. When executing stored computer-executable process steps from the disk 1034, the CPU 1014 stores and executes the process steps out of the RAM 1036.

Read only memory (“ROM”) 1038 may be provided to store invariant instruction sequences such as start-up instruction sequences or basic input/output operating system (BIOS) sequences for operation of the keyboard 1022.

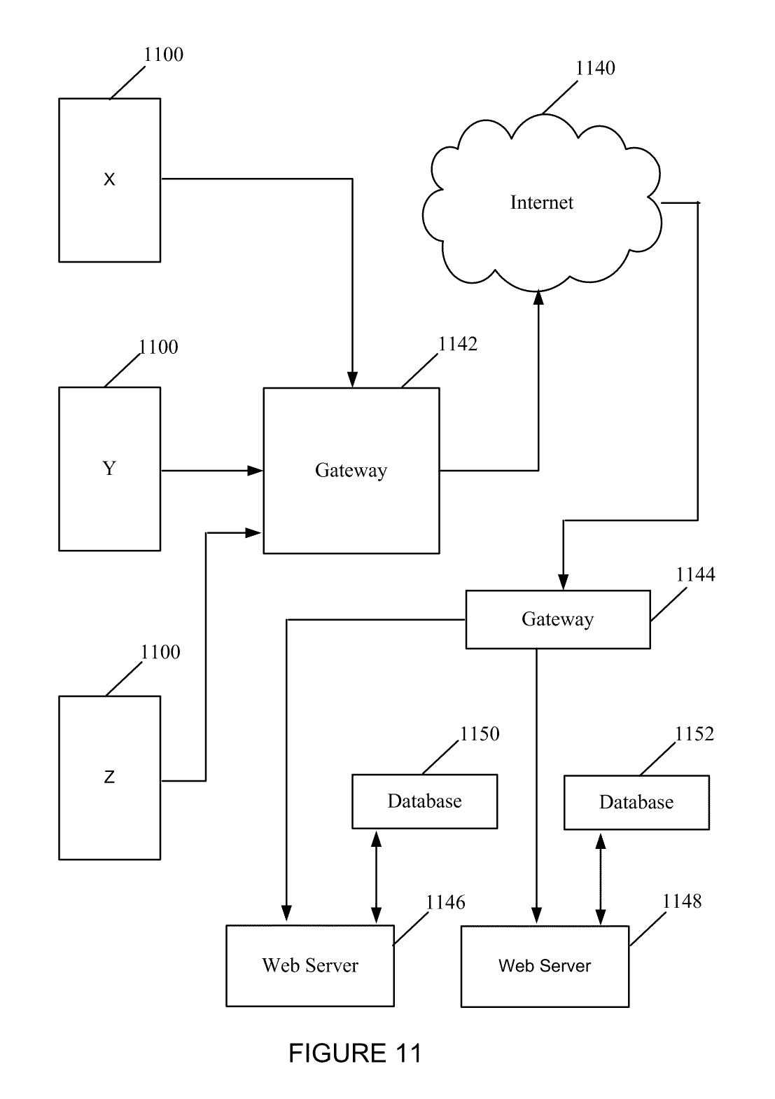

FIG. 11 shows a typical topology of a computer network with computers similar to computer 900, connected to the Internet. For illustration purposes, three computers X, Y, and Z are shown connected to the Internet 1140 via the Web interface 1018 (shown in FIG. 10) through a gateway 1142, where the gateway 1142 can interface N number of computers. The web interface 1018 may be a modem, network interface card, or a unit for providing connectivity to other computer systems over a network using protocols such as X.25, Ethernet, or TCP/IP, or any device that allows, directly or indirectly, computer-to-computer communications.

A second gateway 1144 may connect a network of web servers 1146 and 1148 to the Internet 1142. The web servers 1146 and 1148 may be connected with each other over a computer network. The web servers 1146 and 1148 can provide content, including consumer information from a database 1150 and/or 1152. The web servers 1146 and 1148 can also host the behavior-based web page generation system, according to the disclosure.

The Internet 1140 connects thousands of computers worldwide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (“XML”) as published by W3C Consortium, Version 1, Second Edition, October 2000, ©W3C may also be used. The collection of all such publicly available computer files is known as the World Wide Web (“WWW”).

The WWW is a multimedia-enabled hypertext system used for navigating the Internet 1140 and is made up of hundreds of thousands of web pages with images and text and video files, which can be displayed on a computer monitor. Each web page can have connections to other pages, which may be located on any computer connected to the Internet 1140.

It is noteworthy that the disclosure is not limited to a particular number of computers. Any number of computers that can be connected to the Internet 1140 or any other computer network may be used.

Moreover, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in FIGS. 1-11 may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art.

1. A method, operational on a negotiations manager, for assisting a consumer with negotiations of a purchase of products and/or services, comprising:
receiving search criteria from the consumer and generating a list of potential sellers to participate in the negotiations based on the search criteria;
providing the list of potential sellers to the consumer;
requesting the consumer select a plurality of sellers from the list of potential sellers to receive invitations to participate in the negotiations;
sending the invitations to the plurality of sellers selected by the consumer to inviting each of the plurality of sellers to participate in the negotiations; and
receiving acceptances to the invitations from participating sellers and initiating the negotiations with the participating sellers.

2. The method of claim 1, further comprising receiving quotes from each of the participating sellers.

3. The method of claim 2, further comprising dynamically generating a status report of current quotes from the participating sellers in real time.

4. The method of claim 1, further comprising determining a pre-determined time period for the negotiations.

5. The method of claim 1, further comprising:
receiving a determination of at least one winning seller from the consumer;
notifying the at least one winning seller; and
providing the at least one winning seller contact information of the consumer.

6. The method of claim 5, further comprising receiving an access fee from the at least one seller prior to providing the contact information of the consumer.

7. The method of claim 6, wherein the access fee is a percentage of a final quoted price from the at least winning seller.

8. The method of claim 1, further comprising receiving a participatory fee from each of the participating sellers.

9. The method of claim 1, wherein failure to respond to the invitation is considered a decision to opt out of the negotiations.

10. The method of claim 1, further comprising generating research on the products and/or services to assist the consumer in selecting the search criteria.

11. The method of claim 1, further comprising providing consumer reviews of each seller on the list of potential sellers to assist the consumer is selecting the plurality of sellers.

12. A negotiations manager, comprising:
a memory device;
a seller services module, coupled to the memory device, for allowing sellers to update information on products and/or services for purchase;
a processing circuit coupled the seller services module, the processing circuit adapted to:
receive search criteria from the consumer and generate a list of potential sellers to participate in the negotiations based on the search criteria;
provide the list of potential sellers to the consumer;
request the consumer select a plurality of sellers from the list of potential sellers to receive invitations to participate in the negotiations;
send the invitations to the plurality of sellers selected by the consumer to inviting each of the plurality of sellers to participate in the negotiations; and
receive acceptances to the invitations from participating sellers and initiate the negotiations with the participating sellers.

13. The negotiations manager of claim 12, further comprising a seller database, coupled to the processing circuit, for storing listings of sellers and inventories of products and/or services available for purchase.

14. The negotiations manager of claim 13, wherein the inventories are updated on a daily basis.

15. The negotiations manager of claim 12, wherein the processing circuit is further adapted to receive quotes from each of the participating sellers.

16. The negotiations manager of claim 12, wherein the processing circuit is further adapted to dynamically generate a status report of current quotes from the participating sellers in real time.

17. The method of claim 1, wherein the processing circuit is further adapted to determine a pre-determined time period for the negotiations.

18. The negotiations manager of claim 12, wherein the processing circuit is further adapted to:
receive a determination of at least one winning seller from the consumer;
notify the at least one winning seller; and
provide the at least one winning seller contact information of the consumer.

19. A negotiations manager, comprising:
means for receiving search criteria from the consumer and generating a list of potential sellers to participate in the negotiations based on the search criteria;
means for providing the list of potential sellers to the consumer;
means for requesting the consumer select a plurality of sellers from the list of potential sellers to receive invitations to participate in the negotiations;
means for sending the invitations to the plurality of sellers selected by the consumer to inviting each of the plurality of sellers to participate in the negotiations; and
means for receiving acceptances to the invitations from participating sellers and initiating the negotiations with the participating sellers.

20. The negotiations manager of claim 19, further comprising:
means for receiving a determination of at least one winning seller from the consumer;
means for notifying the at least one winning seller; and
means for providing the at least one winning seller contact information of the consumer.
